(19) United States
(12) Patent Application Publication
(10) Pub. No.: US 2008/0288339 A1
(43) Pub. Date: Nov. 20, 2008

(54) SYSTEMS AND METHODS FOR IMPROVING CUSTOMER RETENTION

(76) Inventors: Tony Streeter, Woodbury, MN (US); Gregg Zastrow, Shoreview, MN (US)

Correspondence Address: SCHWEGMAN, LUNDBERG & WOESSNER, P.A., P.O. BOX 2938, MINNEAPOLIS, MN, 55402, US

(21) Appl. No.: 11/748,188

(22) Filed: May 14, 2007

(51) Int. Cl. G06Q 99/00

(52) U.S. Cl. 705/14

(57) ABSTRACT

An aspect relates to a method for retaining a customer. According to various embodiments of the method, a number of predetermined tasks are performed according to a predetermined schedule when a new account is opened. The predetermined tasks include receiving a reason for creating the account, sending at least one communication to the customer, and providing at least one product offer to the customer. The reason is one of a plurality of predetermined reasons. The at least one communication and the at least one product offer are determined at least in part using the reason for creating the account.

### TECHNICAL FIELD

This application relates generally to systems for improving customer relations and, more particularly, to systems, devices and methods for improving customer retention.

### BACKGROUND

Nearly every business is concerned with retaining customers who have opened new accounts with the business. One reason is that the costs associated with opening an account for a new customer is typically more expensive than the costs associated with retaining customers and their existing accounts or opening new accounts for existing customers.

Companies are looking to refine their account acquisition, retention and growth programs to grow business and retain investment on their new customers and new account openings for their customers. Many industries expend a significant amount of resources to understand the factors that influence customers to remain with a new vendor and the factors that influence customers to abandon a new vendor. Often, consulting firms are employed.

### SUMMARY

An aspect relates to a method for retaining a customer. According to various embodiments of the method, a number of predetermined tasks are performed according to a predetermined schedule when a new account is opened. The predetermined tasks include receiving a reason for creating the account, sending at least one communication to the customer, and providing at least one product offer to the customer. The reason is one of a plurality of predetermined reasons. The at least one communication and the at least one product offer are determined at least in part using the reason for creating the account.

According to various embodiments of a method for retaining a customer, a reason for creating an account is received. The reason is one of a plurality of predetermined reasons. During a first time period after the account is created, a thank you card and an account opening package are sent to the customer using the reason for creating the account. During a second time period after the first time period, a general offer letter with a general product offer is sent to the customer. The general offer is determined using the reason for creating the account. During a third time period after the second time period, a targeted offer letter with a targeted product offer is sent to the customer. The targeted offer is determined using the reason for creating the account.

A system embodiment comprises at least one database and at least one scheduling module adapted to communicate with the at least one database. The database(s) contains client records, customer records for customers of the client, account records, and predetermined reason codes for opening an account. Each account record includes an account opening date. Each account record is associated with a customer record and a selected reason code from the predetermined reason codes. Each customer record is associated with a client record. The scheduling module is adapted to communicate with the at least one database to retrieve the account opening date. The scheduling module is adapted to trigger at least one module to send at least one communication and provide at least one product offer for a selected account record according to a predetermined schedule based on the account opening date. Both the at least one communication and the at least one product offer are based at least in part on the selected reason code for opening the account. The at least one product offer includes at least one offer for goods, at least one offer for services, or at least one offer for both goods and services.

A system embodiment comprises means for receiving a reason for creating an account, means for sending a thank you card during a first time period after the account is created, means for sending an account opening package to the customer using the reason for creating the account during the first time period, means for sending a general offer letter with a general product offer to the customer during a second time period after the first time period, means for determining a targeted product offer using the reason for creating the account, and means for sending a targeted offer letter with a targeted product offer to the customer during a third time period after the second time period. The reason code is one of a plurality of predetermined reasons.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1 illustrates an embodiment of a method to develop customer loyalty.

FIG. 2 illustrates an embodiment of a method for retaining financial institution customers.

FIG. 3 illustrates an embodiment of a method for retaining businesses as financial institution customers.

FIG. 4 illustrates an embodiment of a customer retention system (CRS) according to the present subject matter.

FIG. 5 illustrates an embodiment of a CRS for implementation by a CRS provider providing customer retention services for financial institution clients.

FIG. 6 illustrates a detailed embodiment of a customer retention system (CRS) and data flow diagram according to the present subject matter.

### DETAILED DESCRIPTION

The following detailed description of the present subject matter refers to the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

An aspect of the present subject matter relates to improved systems and methods for a business entity to retain their customers, including new customers who have opened an account and existing customers who have opened a new account. In the financial services industry, for example, approximately 30% of new customers close their account within the first year and approximately half of these customers close their account within the first 90 days. Thus, the first year and especially the first 90 days are particularly important in maintaining new customers. Examples of business entities that provide goods and/or services to customers include, but are not limited to, financial institutions, brokerage firms, insurance companies, heal care providers and health management companies.

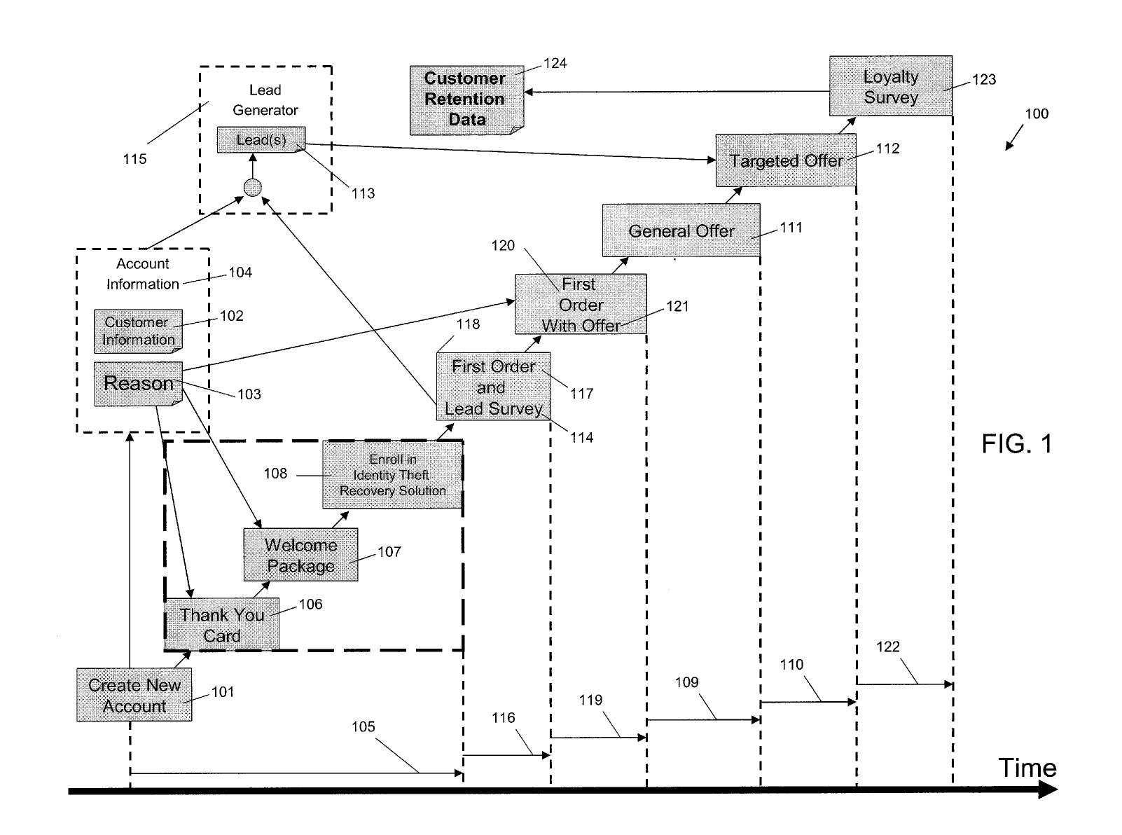

FIG. 1 illustrates an embodiment of a method 100 to develop customer loyalty. The method engages a new customer in a manner to make the customer feel welcome, significant and involved. A customer who feels welcome, significant and involved will develop loyalty to an entity responsible for creating those feelings. Customer interactions, over a determined period of time, include targeted marketing contact based on information provided by the customer.

At 101, a new customer account is created with a business entity for the business entity to provide goods and/or services to the customer. In addition to information about the customer 102 and the type of account being created, a reason 103 for opening the account is also elicited from the customer and associated with the account 104. According to various embodiments, the reason is identified using one-of a predetermined number of reasons for opening the account. For example, reasons a customer may open a new checking account with a financial institution include: the customer has recently moved into area; the customer was dissatisfied with prior financial institution; the new account is customer's first checking account; the customer has other accounts with the financial institution but not a checking account; the customer has recently been married; the customer has recently been divorced; the new checking account is a second checking account for the customer. Any of these reasons or other reasons can be included in the predetermined number of reasons for opening the account. Reasons can be adapted for particular types of accounts and for particular types of businesses.

During a first predetermined time 105 after the account is created, a “Thank You” card 106 is sent to the customer and a welcome package 107 is provided to the customer. According to various embodiments, either the “Thank You” card 106 or the welcome package 107 includes information based on the identified reason 103 for opening the account. In some embodiments, both the “Thank You” card 106 and the welcome package 107 include information based on the identified reason 103 for opening the account. The welcome package 107 includes a welcome letter and promotional items to encourage the customer to seek additional goods, services or combination thereof. The welcome letter, or other documents in the welcome package, may also include information regarding the newly-opened account, and benefits of owning and maintaining the newly-opened account. For example, where the entity upon whose behalf the communications are provided is a financial institution, the marketing items may include, personalized account identification cards, coupons inviting the customer to convert other accounts or financial services of another financial institution to the new financial institution and a check selection guide for ordering checks. The content of the welcome package, including the welcome letter content and the promotional items, can be tied to the reason 103 for setting up the account.

Additional customer contact may also take place during the first predetermined time period 105 after the creation of the new account. For example, a financial institution may, either automatically or with customer approval, enroll a new checking account customer in a fraud recovery service 108 to provide an identity theft recovery solution for a limited time and provide the customer with information regarding the service within the welcome package 107 or an additional communication.

Additional product offerings are provided to the customer during a second 109 and third 110 predetermined time period following the first time period 105. During the second predetermined time period 109, the customer is provided with a general or non-targeted communication 111. The communication 111 may contain an additional welcome message, an explanation of features associated with the customer's account and a general product offer 111 of additional goods, services or combination of goods and services the customer has not, as yet, ordered. In various embodiments, where the new account is held at a financial institution, a brokerage firm or insurance company, the general product offer communication 111 includes an invitation to visit the local office or branch office of the institution, firm or company. In various embodiments, where the account has been created with a healthcare provider or health management company, the general communication 111 may include an invitation to visit an affiliated health clinic near the customer's residence or work.

At the conclusion of a third predetermined time period 110, following the second predetermined time period 109, the customer is provided with a targeted product offer 112. In various embodiments, the basis of the targeted offer 112 includes behavior information gathered from monitoring the customer's use of the new account, a lead 113 generated from the results of a survey 114 conducted with the customer, general marketing information collected by the entity managing and/or administering the account or a combination thereof. To increase the effectiveness of the targeted offer 112, the information available is analyzed 115 to determine the at least one product offering that would most interest the customer. For example, for financial or investment institutions, if behavior information gathered from the new account indicate the customer has a particular interest in investments, the targeted offer may include a certificate of deposit (CD) with a higher than normal rate of return if the customer opens the CD within a specified period of time. Likewise, if the behavior information indicates the customer has recently purchased a car, a financial institution may forego offering the customer an auto loan and instead offer a refinancing incentive, if practical.

As identified by the method illustrated in FIG. 1, some embodiments involve a first order within a fourth predetermined time period 116 after the first predetermined time period 105 and prior to extending the general 111 and targeted 112 product offering. The customer initiates or is contacted to initiate a first order of goods and/or services 117 within the fourth predetermined time period 116. Order information may be collected, for example, over the internet, using a call center or using a postal or delivery service. During the ordering process 118, a lead generation survey 114 can be performed according to some embodiments. The information provided by the customer in the lead generation survey 114 is analyzed in a lead generation application 115 along with the customer's account information 104, including the reason 103 for creating the account. The lead generation application 115 generates at least one lead indicating a good, service or combination thereof the customer may be interested in purchasing. In various embodiments, the lead 113 forms the basis of future communications with the customer, including the targeted product offering 112 previously discussed. In other embodiments, the lead 113 does not form the basis of future communications with the customer.

Where the lead generation survey 114 is conducted by an administrative entity providing a service to, for example, a financial institution, the administrative entity provides survey information to the financial institution on a regular basis using mail, e-mail, an internet interface or other communication means. For instance, when a new lead or a group of new leads is generated by the administrative entity, the leads can be downloaded to a database within the financial institution's computer system, or an e-mail can be sent to the branch manager or managers of the financial institution alerting them to access the lead through the administrative agency's website access. Additional e-mails may be sent if a manager or managers fail to take action on a lead. Account information associated with the new leads, such as the zip code of the customer associated with an account, may be used to determine which branch manager is alerted to a particular lead.

During a fifth predetermined time period 119, illustrated in the embodiment of FIG. 1 as following the fourth predetermined time period 116 and prior to the second predetermined time period 109, the customer's first order is delivered 120. As part of the order, an offer 121 of goods and/or services is provided. The offer 121 is personalized and based on the reason 103 the customer provided for opening the account. For example, where the account is a checking account created at a financial institution, and the account was created because the customer recently moved into the area, the offer may include a reduced or a particular rate on a home equity line of credit to fix up the new home. For a financial institution, such an offer is integrated within the boxes of check delivered with the first order.

Some embodiments involve a loyalty survey 123, illustrated in the embodiment of FIG. 1 as occurring during a sixth predetermined time period 122 following the third predetermined time period 110 previously discussed. The customer answers the loyalty survey, and the results of the loyalty survey 123 assist in determining the customer's view of the entity, including whether the customer would recommend the entity to others. The loyalty survey 123 may be conducted, for example, over the phone, using e-mail or using a postal or delivery service. In various embodiments, information 124 from the loyalty survey 123 is used to assess the effectiveness of the customer retention method and may be used to modify the content of future communications to make the method more effective.

In various embodiments of the illustrated method of FIG. 1, the termination of one time period and the beginning of an adjacent time period may overlap such that the beginning of one time period may be at or near the end of the immediately preceding time period. Additionally, various embodiments may include gaps of time between the conclusion of one time period and the next proceeding time period.

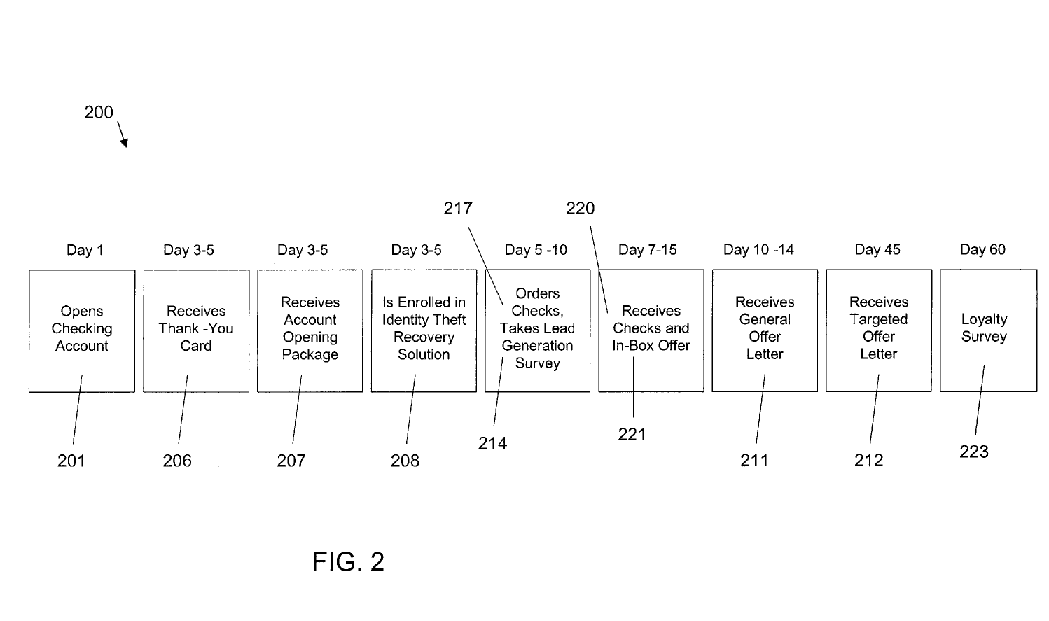

FIG. 2 illustrates an embodiment of a method 200 for retaining financial institution customers. The financial institution provides a series of communications and product offerings to encourage a new customer to maintain the new account with the financial institution. The communications and product offerings may be made by either the financial institution or a third party service provider on behalf of a financial institution client. A customer opens a new personal checking account 201. Upon opening the checking account, information about the customer and the account is received by the financial institution. The financial institution elicits from the customer a reason for opening the checking account and includes the reason with the other information associated with the account. According to various embodiments, the reason is selected from a predetermined number of reasons.

In the illustrated embodiment, the financial institution, a third party service provider, or combination thereof provides a number of communications with the customer within three to five days of creating the account. A “Thank You” card 206 is sent to the customer. The “Thank You” card 206 is personalized and may include information related to the reason provided by the customer for opening the new checking account. Also within three to five days of opening the new checking account, the customer receives a welcome package 207 provided by the financial institution or a third party service provider on behalf of the financial institution. In various embodiments, the welcome package 207 contains information related to the reason the customer provided for opening the new checking account. In various embodiments, the welcome package includes information related to the financial institution, information related to the new account, personalized account identification cards, personalized checks, personalized deposit slips, a check selection guide for ordering checks and promotional coupons inviting the customer to enroll in or switch to additional financial services they may desire or have managed by a competing financial institution.

According to some embodiments of the method, the financial institution provides the customer with information on complimentary accounts, programs or services as a feature of the new checking account. For example, a financial institution may enroll new account customers in a fraud recovery service 208 for a complimentary period of time upon the opening of the new account. The welcome package 207 may include information directed toward the fraud recovery service and features available under the complimentary membership, as well as, features available for further purchase. According to an embodiment of a fraud recovery service, a customer contacts a fraud recovery unit after they believe that they may have become a victim of identity theft. For a predetermined amount of time (e.g. six months) following the incident, the service provides daily monitoring of a credit bureau, notification (e.g. telephone, email, letters, faxes, text messaging) to the customer of changes in the credit bureau records, and support in recovering the customer's identity. An embodiment of the service also provides identification theft insurance.

The customer places an initial order 217 for checks, which is expected to occur within 5-10 days after opening the new account. The customer may place the order 217 for the checks over the phone or via web site. As part of placing the initial order 217, the customer is invited to respond to a lead generation survey 214. The results of the lead generation survey 214 are used to generate leads. The leads are determined from the survey results and indicate the customer's next most likely product purchase(s) from the financial institution. The leads may be classified as to their probability of resulting in a purchase where the most likely leads to result in a purchase are labeled “hot” and lesser probability leads classified as “warm”, “cold” or “future” depending on the circumstances of the customer. After the leads are generated and stored in a database, an e-mail is sent to the appropriate branch manager or managers to notify them of the leads. The branch manager(s) then follow-up on the lead to the customer's satisfaction and note their actions in the database. If a manager fails to take action on a lead, reminder e-mails may be forwarded to the manager(s) or other authorized personnel. Some embodiments send the lead to an administrative agent (a human or automated agent) or to a pool of manager(s) to assist the institution with taking appropriate and timely action on the leads.

During a period of time approximately 7 to 15 days after the account is opened, a first order of checks is delivered 220 to the customer. In the illustrated embodiment, the first package of checks also includes an offer 221 based on the reason provided by the customer for opening the checking account. For example, if the customer opened the checking account because of a recent move, the offer 221 may include a special rate on a home improvement loan or home equity line of credit.

During a period of time approximately 10-14 days after the account is opened, the customer is sent a general product offer 211 of additional goods and services provided by the financial institution. Where third party services providers (an entity other than the business entity or its customer) initiate the delivery of the general offer 211 on behalf of the financial institution, various communication, database and applications modules, both hardware and software, are used to facilitate the transfer and updating of customer information related to the new account. The modules allow the third part service providers to build the appropriate message and product offer to each particular customer and allow the financial institution to monitor the communications provided to customers on the institution's behalf.

Within a time period extending from approximately day 40 to approximately day 50 (illustrated as occurring on the 45^{th} day) following the opening of the account, a targeted product offering 212 is sent to the customer on the behalf of the financial institution. Again, where the communication is developed and or sent by third party service providers, communication, database and application modules are used to facilitate delivering to each customer the appropriate targeted offer. In various embodiments, the targeted offer 212 is based on at least one of several factors including the reason provided by the customer for opening the account, a lead generated from a lead generation survey 214 conducted upon placing the customer's first check order 217, and the customer's use of the account as collected by the financial institution and stored in a marketing database such as a Marketing Central Information File (MCIF) system, for example.

Within a time period extending between approximately day 50 to approximately day 70 (illustrated as occurring on the 60^{th} day) following the opening of the account, the customer is invited to complete a loyalty survey 223. The survey includes questions and/or invitations for the customer to comment on the customer's opinion of the institution and their intent on allowing the institution to continue serving their account(s). In various embodiments, questions or invitations to comment included with the loyalty survey 223 elicit the customer to offer their opinion of the financial institution as a whole, the customer's willingness to recommend the institution and other loyalty determining topics.

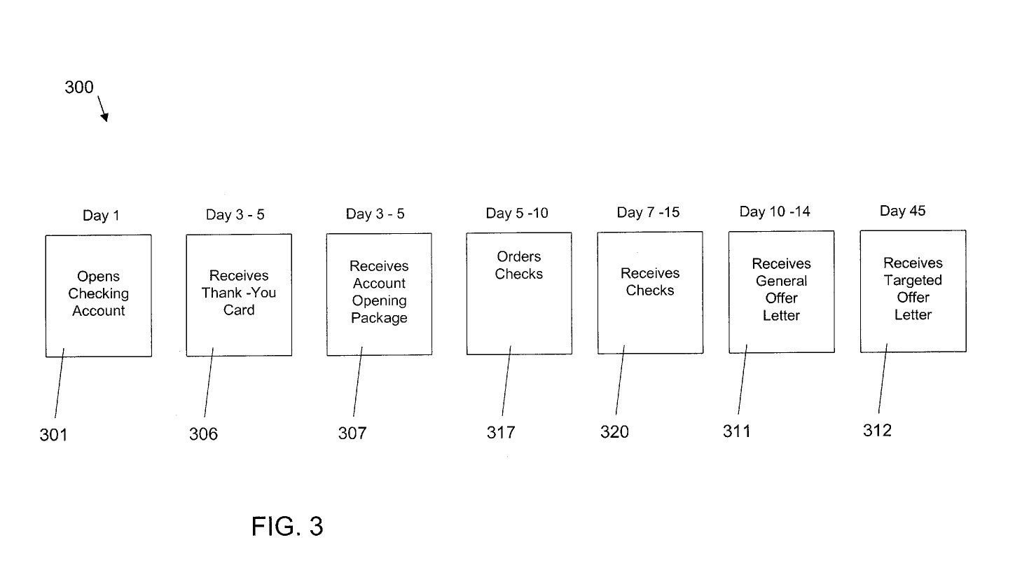

FIG. 3 illustrates an embodiment of a method 300 for retaining businesses as financial institution customers. The business checking account is opened 301. Like the personal checking account, a reason for opening the account will be associated with the account. The reason for the business account may be used to identify the type of small business associated with the account. Future communications and product offers are based not only on the reason provided by the small business customer for opening the account but also on the type of business associated with the account. Examples of business types of interest to financial institutions include, retail, wholesale, manufacturing, distribution, professional and franchise

Within three to five days of creating the account, either the financial institution, a third party service provider, or combination thereof provides a number of communications with the small business customer. A “Thank You” card 306 is sent to the small business customer. The “Thank You” card 306 is personalized and may include information related to the reason provided by the small business customer for opening the new checking account or a reference to the type of business associated with the account. Also, within three to five days of opening the new checking account, the small business customer receives a welcome package 307 provided by the financial institution or a third party service provider on behalf of the financial institution. The welcome package 307 may include information related to the reason the small business customer provided for opening the new checking account, including the type of business associated with the account. In various embodiments, the welcome package 307 includes information related to the financial institution, information related to the new account, personalized account identification cards, personalized checks, personalized deposit slips, a check selection guide for ordering checks and promotional coupons inviting the small business customer to enroll in, or switch to, additional financial services they may desire or are currently being managed by a competing financial institution.

FIG. 3 further illustrates the small business customer placing an initial order 317 for checks, expected to occur within 5-10 days after opening the new account. The small business customer may place the order 317 for the checks using a phone or the internet using a web site. In a time period extending from approximately 7 to 15 days after the account is opened, a first order of checks is delivered 320 to the small business customer.

In a time period extending from approximately 10 to 14 days after the checking account is opened, the illustrated embodiment indicates that the small business customer is sent a general product offer 311 of additional goods and services provided by the financial institution. Where a third party service provider initiates the delivery of the general offer 311 on behalf of the financial institution, various communication, database and application modules, both hardware and software, are used to facilitate the transfer and updating of customer information related to the new account.

Within a time period extending from approximately day 40 to approximately day 50 (illustrated as occurring on the 45^{th} day) following the opening of the account, a targeted product offering 312 is provided to the small business customer on the behalf of the financial institution. Again, where the offer 312 is developed and/or sent by third party service provider, communication, database and application modules are used to facilitate delivering to each customer the appropriate targeted offer. The targeted offer is based on at least one of several factors. These factors can include the reason provided by the customer for opening the account, a lead generated from the financial institution's small business marketing information and the small business customer's use of the checking account as collected by the financial institution and stored in a marketing database such as a Marketing Central Information File (MCIF) system, for example.

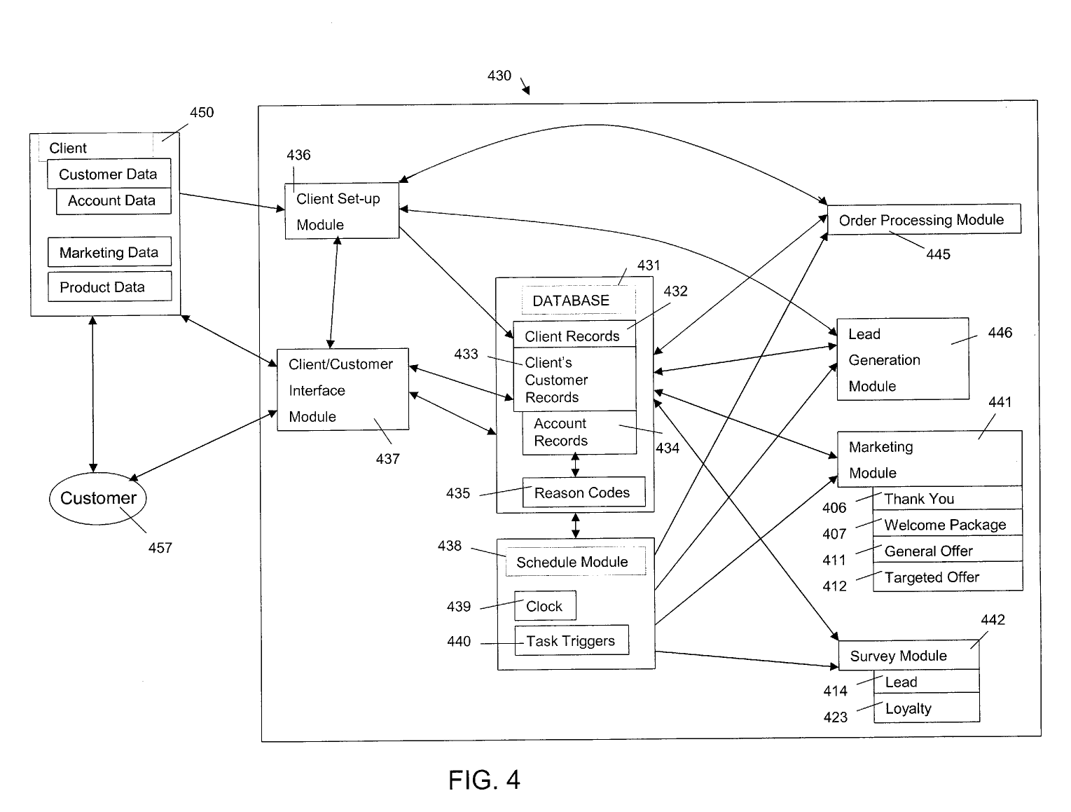

FIG. 4 illustrates an embodiment of a customer retention system (CRS) 430 according to the present subject matter. In the illustrated embodiment of the system, a third party CRS (a CRS provided by an entity other than the business entity (e.g. financial institution) or its customer) supports the efforts of a business entity (a client of the third party CRS provider) to retain its new customers and the customer's new accounts. The system includes a customer retention database (CRDB) containing client records 432, each client's customer records 433, each client's customer's account records 434 and a predetermined list of reason codes 435. Each client's customer's account record 434 has a reason code associated with the account. Each client's customer's account record 434 includes an account opening date for each account. Client records for each client are setup in the database and updated as needed using a client setup module 436. Client records 432 include, for example, client billing information, client logo files, client communication protocols and specifications, the client's customer communication templates and schedule rules for communications and offers extended to the client's customers on behalf of the client by the CRS 430. The client and the client's customers do not form part of the CRS 430 but interact with the system through a client and customer interface module 437. In various embodiments the client and customer interface module may be implemented as a telephone call center facility, an internet web application or a combination thereof.

The client and customer interface 437 module allow the client's data system and the CRS databases 431 to exchange data as needed to facilitate the timely delivery of communications and product offers to the client's customers. The client and customer interface module 437 also provides the client with a means to monitor the customer retention system's activities with respect to the client's customers and their accounts. In various embodiments, the client and customer interface module 437 also allow customers to monitor their accounts.

The illustrated CRS 430 also includes a number of modules adapted to perform various functions required by a particular client's customer retention protocol. The illustrated customer retention system includes a schedule module 438. The schedule module 438 includes a clock 439 and a list of task triggers 440 forming a schedule for initiating a number of communications between the CRS 430 and each client and between the CRS 430 and clients' customers on behalf of each client.

The illustrated CRS 430 includes a marketing module 441 which performs a number of marketing tasks according to a client's particular task list 440 as triggered by the scheduler module 438. In various embodiments, the marketing module 441 performs tasks including, sending personalized “Thank You” cards 406 to clients' customers whom have recently opened new accounts, sending welcome packages 407 to clients' customers whom have recently opened new accounts, providing general 411 and targeted 412 offers to clients' customers. When these tasks are initiated by the scheduler module 438, the marketing module 441 facilitates the transfer of information from the CRDB 431 and other CRS modules such that the appropriate message or offer is assembled and delivered to a client's customer. For example, sending a “Thank You” card 406, a welcome package 407, or a targeted offer 412 require the marketing module 441 to collect information specific to a client and the client's customer's account. In various embodiments, the specific information includes a message or offer associated with the reason code provided by the customer when the account was opened.

The CRS includes a survey module 442. The survey module 442 initiates, monitors and provides results of surveys to the CRDB 431 when triggered by the scheduler module 438. In the illustrated embodiment, the survey module 442 coordinates the initiation, monitoring and reporting of results for a lead survey 414 and a loyalty survey 423. In various embodiments, the survey module 442 collects information to be included on each survey from the CRDB 431. The information collected may include specific questions or statements to elicit particular opinions of a customer desired by the client upon whose behalf the survey is conducted. The lead survey 414 seeks to identify products a customer is most likely to next purchase from the client associated with the surveyed customer. In various embodiments, the lead survey 414 is conducted when a client's customer places an initial order. In various embodiments, the lead survey 414 may be conducted using a call center or through an interactive web application using the internet. The loyalty survey 423 is conducted to elicit loyalty information from customers including, for example, a customer's overall opinion of a client and the customer's propensity to recommend the client to another potential customer.

The illustrated CRS 430 includes an order processing module 445. In the illustrated embodiment, a client may have custom information setup in the order processing module 445 dictating parameters by which the order processing module will initiate, monitor and report orders associated with the client's customer's accounts. The order processing module 445 responds to triggers generated by the scheduler module 438. Upon receiving a trigger from the scheduler module 438, the order processing module 445 extracts order information for an account from the CRDB 431, matches the account information up with the proper client information, and requests production of the order and monitors and reports the progress of the order through billing. Where the client is a financial institution and the CRS 430 is managed by a third party CRS provider, an order for checks corresponding to a recently opened checking account is an example of a task the order processing module handles. In addition to the specific information necessary to identify the customer's checks, the order processing module 445 collects client information from the CRDB 431. Client information collected from the CRDB 431 includes specific information to identify the client for production of the order, as well as, for example, the client's logo to be included on the checks or supporting documents.

The illustrated system of FIG. 4 also includes a lead generation module 446. The lead generation module 446 collects the results of the lead survey 414 transferred to the CRDB 431 by the survey module 442 and analyzes the results to generate leads indicating products a particular customer is most likely to purchase next. On a regular basis, for example, daily or weekly, the lead generation module 446 performs a geographic match of customer zip codes against corresponding client branch office locations for each customer lead generated by the lead generation module 446. Using the geographic zip code match, the lead generation module 446 locates the nearest branch office and e-mails a lead notification to each branch office contact such that the lead may be accessed from the CRDB 431 and pursued. In various embodiments, the lead generation module 446 monitors the disposition of each lead and may restrict access to future leads until the status of pending leads are updated by the branch manager responsible to follow-up on each lead.

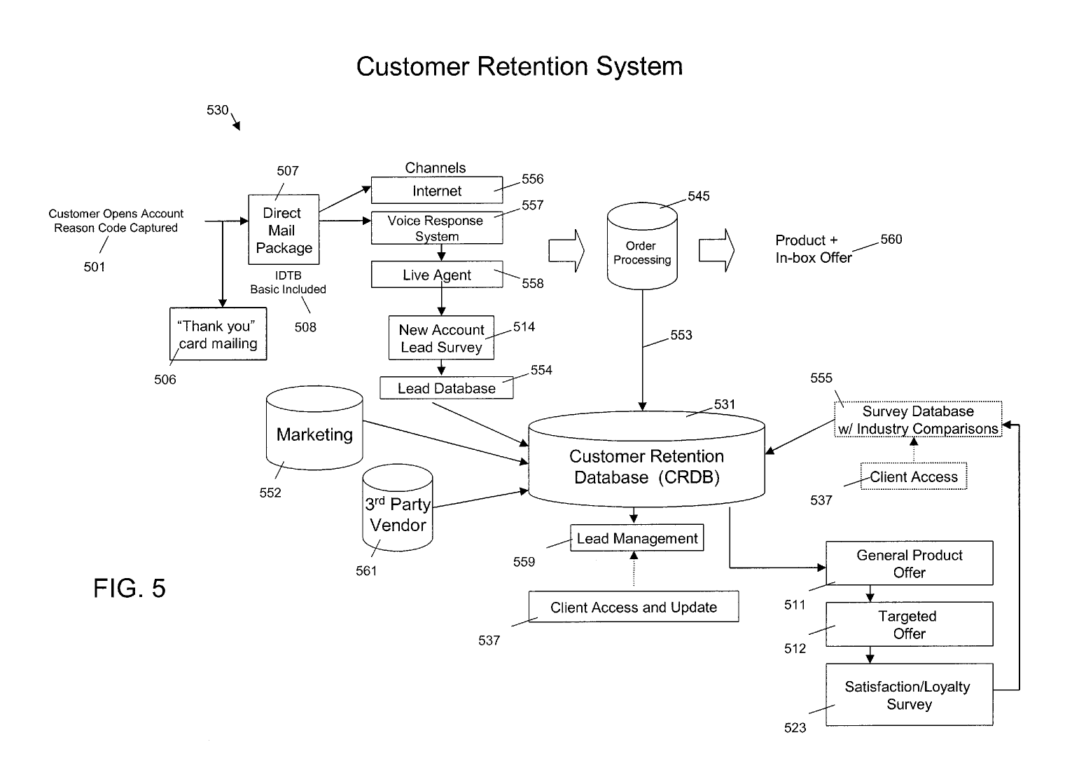

FIG. 5 illustrates an embodiment of a CRS for implementation by a CRS provider providing customer retention services for financial institution clients. The illustrated system shows both general information flow and system components according to the present subject matter. The system focuses on the information received by and extracted from a customer retention database (CRDB) 531. In various embodiments, the CRDB 531 may include a network of databases. In the illustrated embodiment, information received by the database includes client data, marketing data 552, customer and customer account data, customer order data, lead generation data 554 and survey data 555. Information extracted from the database is used to perform tasks unique to each client's efforts to retain customers who have recently opened new accounts with the client. Those customer retention tasks include providing each client's customers with personalized communications, receiving, requesting and monitoring client customer orders, initiating and conducting customer surveys on behalf of each client, updating the information within the CRDB system on a regular basis, and providing client access to the system 537.

In the illustrated system of FIG. 5, client information is received by the CRDB 531 when each financial institution client subscribes to the services provided by the CRS provider. In addition to client identification information such as name of client, addresses, telephone numbers and logos, a list of tasks and a schedule to initiate the tasks is associated with each client. In some embodiments, the list of tasks correspond to the level of customer retention services to which the financial institution has subscribed. Customer and customer account information is received by the CRDB 531 when a customer opens a new account 501 with a client financial institution. According to the client schedule stored in the CRDB 531, upon creating a new account with the client, the CRS initiates several tasks using information extracted from the CRDB 531. In the illustrated example, after a customer creates an account 501, the CRS initiates providing a “Thank You” card 506 and a welcome package 507 to the customer. The “Thank You” card 506 and the welcome package 507 contained personalized messages directed to information collected at the time the customer opened the account 501 such as a reason provided by the customer for opening the account. Additionally, both the “Thank You” card 506 and the welcome package 507 will contain information, graphics and messages indicating the card and package were sent on behalf of the client associated with the customer's account. In various embodiments, complimentary products associated with either the client or the CRS provider may be brought to the attention of the customer through the “Thank You” card or the welcome package or both. For example, in the illustrated system, upon opening a new account 501, a customer is enrolled in a basic fraud recovery service 508 to provide an identity theft recover solution for a complimentary period of time.

In the illustrated embodiment, the “Thank You” card 506 and/or welcome package 507 include instructions on placing an initial check order when the new account is a checking account. The illustrated CRDB 531 receives order information through several communication channels including the internet 556, telephone voice response system 557 and a telephone call center 558. After placing an order, the CRS may invite the customer to take a lead generation survey 514 on behalf of the client associated with the customer's account. The lead generation survey 514 is designed to elicit from the customer the client's product or products the customer is most likely to purchase next. The CRDB 531 receives the results of the lead generation survey 514 and notifies the client that leads exist in the CRDB 531. The client is allowed password protected access the CRDB 531 through a lead management module 559 to obtain the lead information for follow-up with the customer and to update the lead information to indicate the status of the follow-up efforts. In various embodiments, restrictions on future lead access may be implemented until a client's contact updates pending leads. Conditions for restricted access to future leads can be based on information received by the CRS 530 from the client and stored in the CRDB 531 with other client information.

The CRS 530 processes and manages order production using an order processing module 545. The illustrated system shows an order processing module 545 for an initial order of checks for use with a recently opened checking account. The order processing module 545 will extract information from the CRDB 531 to initiate and monitor the production of the customer's check order. Information extracted from the CRDB 531 by the order processing module includes customer information, customer account information, client information including the client's logo, check template information for printing the checks and marketing information 552. The marketing information 552 is extracted by the order processing module to provide offers to the customer where the offers are included with the checks upon delivery of the checks to the customer. Such an offer is referred to as an in-box offer 560. In various embodiments, the in-box offer included with the checks may include offers related to the reason provided by the customer for opening the checking account. For example, where the customer has indicated the checking account was opened because the customer recently moved to the area, a home equity line of credit or reduced rate on a home improvement loan may be the subject of the in-box offer 560.

In various embodiments, the CRS 530 continues to provide additional offers to the customers on behalf of the client associated with each customer over a period of time. The offers are triggered at predetermined times according to each client's set-up information. The offers include both general 511 and targeted 512 offers of each client's products. The general offers 511 are provided to customers by the CRS n behalf of the client associated with customer's account to raise awareness of additional goods and services available to the customer through the client. In various embodiments, the CRS, in cooperation with the client, only offers products the customer is potentially able to accept. For example, if the customer already has a money market account with the client, an offer to open a money market account is not extended in a general offer to the client's customer.

Targeted offers 512 are provided to customers by the CRS on behalf of the clients associated with each customer account to present a timely offer likely to interest each specific customer. In addition to client, customer and customer account data, targeted offers 512 rely on marketing data 552 received by the CRS and stored in CRDB 531. In various embodiments, the marketing data received by the CRS includes marketing data from each client's own marketing database system, marketing data collected by the CRS provider, marketing data collected from third party vendors 561 (an entity different from the business entity, the business entity's customer and the third party CRS provider) or combinations thereof. In various embodiments, marketing data received by the CRS from a client's marketing database system includes data collected from the customer's use of the recently opened account or other data reflecting the customer's behavior with respect to the client's portfolio of products.

In various embodiments, the CRS initiates a loyalty survey 523 of a customer on behalf of the client associated with the customer's recently opened account. The loyalty survey 523 is triggered at a predetermined time according to each client's set-up information. The loyalty survey 523 is initiated to elicit from customers their opinions related to loyalty issues. The results of the loyalty survey 523 are received by the CRS and stored on the CRDB 531. In the illustrated example, the results are stored in a survey database 555 within the CRDB system 531 along with industry comparison data. In various embodiments, client access 537 is allowed to the survey database. The results of the loyalty survey may be used by the clients to assess the effectiveness of customer retention tasks and modify the tasks to further improve their effectiveness. In various embodiments, the CRS will provide a third party vendor with information and parameters to generate and/or conduct the loyalty survey with client customers.

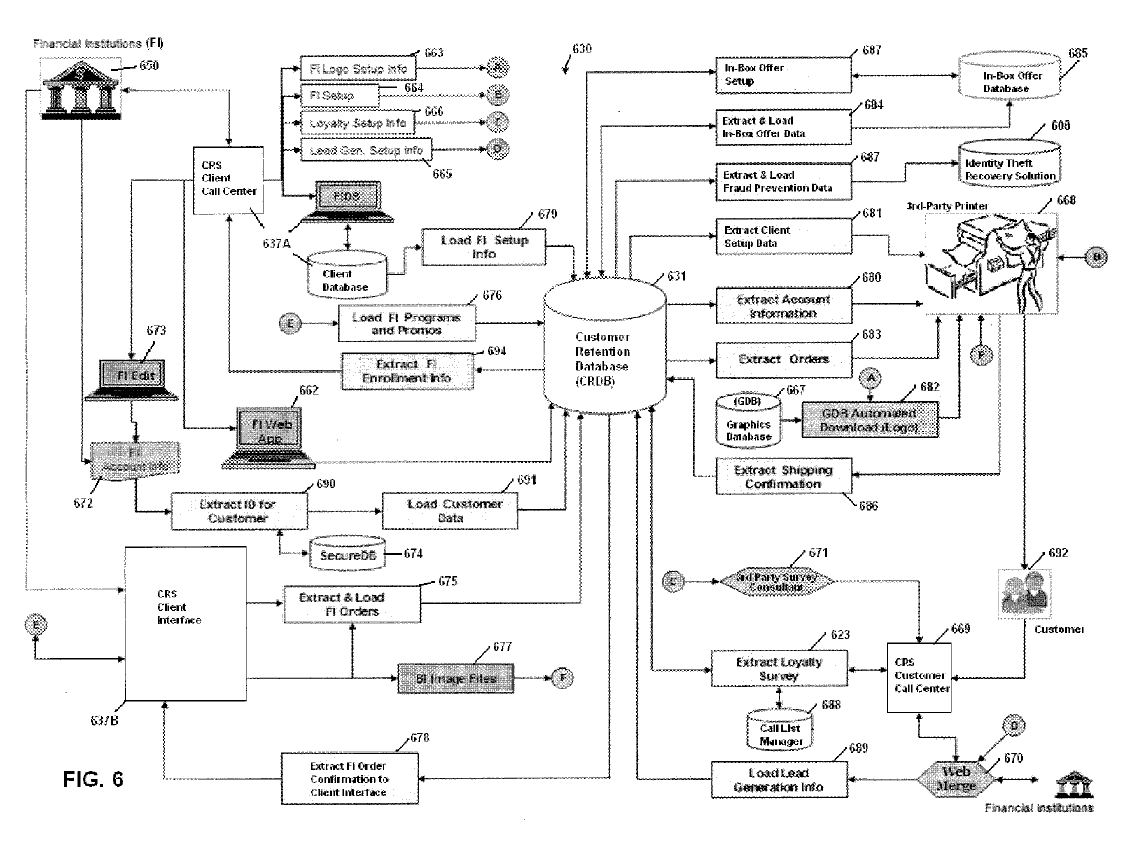

FIG. 6 illustrates a detailed embodiment of a customer retention system (CRS) and data flow diagram according to the present subject matter. The CRS includes a Customer Retention Database (CRDB) 631. Unlike the illustrated example, in various embodiments, the CRDB 631 includes multiple databases adapted to communicate and interact with each other. In the illustrated system, a client financial institution (FI) 650 subscribes service from a CRS provider. Upon subscribing, the FI 650 and CRS 630 exchange data to set the client up in the CRS. Several methods of exchanging information between the FI 650 and the CRS 630 are available. The methods of exchanging client setup information between the client FI 650 and the CRS provider include a client call center 637A with e-mail access, the internet using ftp and a web based applications 662, or a combination thereof.

Information exchanged through the client call center 637A include the FI's logo setup information 663, FI Setup information 664 such as templates for printing checks, letters and other communications and rules or parameters to guide the CRS in triggering communications and other events according to the FI's customer retention needs, lead generation survey information 665 specific to the client and loyalty survey information 666 specific to the client. In various embodiments, the CRS provider client call center gathers the FI setup information and e-mails the information or notices to various storage devices or third party vendors where the information will eventually be used. For example, the FI logo information is sent to a graphics database 667, the printing department or third party printers 668 are emailed templates or notifications that templates are available in the CRDB 631, lead generation survey information 665 is collected and made available to the CRS's customer call center 669 via a web based application 670 for use in conducting a lead survey 689 and loyalty survey information 666 is forwarded to a third party survey consultant 671 for assistance in producing loyalty survey content. In various embodiments, reports providing status information of a clients enrollment activities 694 is extracted from the CRDB 631 and provided using the client call center 637A, as illustrated, or other client interface methods, such as e-mail.

In various embodiments, client information exchanged over the internet to the CRS provider includes transfers of recently opened customer account information. In the illustrated example, the client customer account files 672 may be edited by the client call center personnel using a FI Edit application 673 prior to the information being stored in the CRDB 631. Additionally, the CRS provider may take precautions to protect the Social Security Number SSN information contained in the client customer account files using a secure database 674 that replaces the SSN information associated with a customer or an account. The CRS replaces 690 the SSN information with a CRS system identification prior to the account information being stored 691 in the CRDB 631. The relationship between the SSN information and the CRS system identification remains encrypted on the secure database 674.

In various embodiments, the client FI 650 exchanges data with the CRS using other client interfaces 637B, including web based client interfaces. Data exchanged over the web based client interface include order information 675 and client specific promotional and sales program information 676. As the client enters information concerning orders and promotions, the CRS client interface extracts particular information and loads it into the CRDB 631. For example, sales programs and promotional information 676 is extracted and loaded separately in the CRDB 631. Order information 675 is extracted from the customer interface with graphic data 677 pertinent to the orders being extracted and stored separately from other order data or forwarded to a third party vendor 668 for later use. The CRS client interface 637B can also exchange data from the CRS to the client. For example, order confirmation data 678 can be extracted from the CRDB and made available clients using the CRS client interface.

After a customer opens an account with a subscribed FI, and the account information is loaded 679 into the CRS 630 and stored on CRDB 631, the CRS begins to execute the tasks specified in the FI's setup information stored on the CRDB 631. Providing a “Thank You” card and a welcome message to customers are examples of tasks the CRS initiates on behalf of each FI associated with a newly opened customer account. The illustrated CRS uses at least one third party printer 668 to produce and provide to the customer the “Thank You” card and the welcome package. As one of ordinary skill in the art will appreciate, upon reading and comprehending this disclosure, activities associated with or assigned to a third party vendor may be internalized by the CRS provider. Third party vendors 668 may also be used to produce the orders discussed above. In the illustrated example, a third party printer 668 is used to produce initial check orders placed by FI customers or placed by FI's on behalf of their customers. When a task employing a third party vendor is initiated by the CRS, the CRS extracts information from the CRDB and forwards it to the third-party vendors. For example, when a “Thank You” card or welcome package is scheduled to be sent to a customer, the CRS extracts from the CRDB the customer information and customer account information 680, the client FI information 681, graphic and template information 682 for the “Thank You” card and any personalized message based on information 683 supplied by the customer according to rules and parameters specific by the FI in the FI setup information. The CRS assembles the information and transfers it to the third-party vendor 668 for production and delivery of the “Thank You” card. Similar data extraction and assembly takes place when the customer order is initiated by the CRS. In addition, the CRS coordinates the extraction and transfer of in-box offer information 684 such that an in-box offer is produced with a customer's initial order of printed checks. In various embodiments, options for the in-box offer are determined independent of a customers order. The options for the in-box offer in these embodiments may be setup 687 prior to an actual order event and information related to the production and coordination of the in-box offer may be stored in a In-Box Offer database 685 separate from the CRDB 631 within the CRS 630.

In various embodiments, after a task such as requesting the production of a customers check order is initiated, the CRS will extract from the printing department or third party vendors updates on the progress of the customer order. For example, the illustrated system shows the CRS system extracting shipping confirmation data 686 from the third party printer 668.

FIG. 6 illustrates the CRS system extracting data 693 from the CRDB 631 to facilitate enrolling customers in a fraud recovery service 608. In various embodiments, a financial institution may enroll a new account customer in a fraud recovery service 608 for a complimentary period of time.

In various embodiments, at a predetermined time after a customer has opened an account with a subscribing financial institution client 650, the CRS system will extract customer and client information from the CRDB 631 to conduct a loyalty survey 623. In various embodiments, a call list manager application 688 or database will be updated with information and alerts for use by a CRS customer call center 669 for conducting loyalty surveys 623 with customers 692. In various embodiments, a third party consultant 671 is used to develop survey content to elicit the opinions desired by each client from the customers through the loyalty survey 623. Results of each loyalty survey are stored on the CRDB 631. In various embodiments, the results of the survey are made available to the client financial institutions through a web based application 670 of the third party vendor.

One of ordinary skill in the art will understand that, the modules and other circuitry shown and described herein can be implemented using software, hardware, and combinations of software and hardware. As such, the terms module and circuitry, for example, are intended to encompass software implementations, hardware implementations, and software and hardware implementations.

The methods illustrated in this disclosure are not intended to be exclusive of other methods within the scope of the present subject matter. Those of ordinary skill in the art will understand, upon reading and comprehending this disclosure, other methods within the scope of the present subject matter. The above-identified embodiments, and portions of the illustrated embodiments, are not necessarily mutually exclusive. These embodiments, or portions thereof, can be combined. In various embodiments, the methods are implemented using a computer data signal embodied in a carrier wave or propagated signal, that represents a sequence of instructions which, when executed by a processor cause the processor to perform the respective method. In various embodiments, the methods are implemented as a set of instructions contained on a computer-accessible medium capable of directing a processor to perform the respective method. In various embodiments, the medium is a magnetic medium, an electronic medium, or an optical medium.

The above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for retaining a customer, comprising:
performing a number of predetermined tasks according to a predetermined schedule when a new account is opened, including receiving a reason for creating the account, sending at least one communication to the customer, and providing at least one product offer to the customer,
wherein the reason is one of a plurality of predetermined reasons, and the at least one communication and the at least one product offer are determined at least in part using the reason for creating the account.

2. The method of claim 1, wherein the at least one product offer includes at least one offer for goods, at least one offer for services, or at least one offer for both goods and services.

3. The method of claim 1, wherein the new account is an account for a financial institution.

4. The method of claim 3, wherein the account is a personal account.

5. The method of claim 3, wherein the account is a business account.

6. The method of claim 1, wherein sending at least one communication to the customer includes sending a personalized thank-you card to the customer.

7. The method of claim 1, wherein sending at least one communication to the customer includes sending a personalized account opening package to the customer.

8. The method of claim 1, wherein performing the number of predetermined tasks includes enrolling the customer in a fraud recovery service during the at least one predetermined time period.

9. The method of claim 1, wherein performing the number of predetermined tasks includes receiving a first order from the customer, receiving customer responses to a lead generation survey, and generating at least one lead using the customer responses.

10. The method of claim 9, wherein performing the number of predetermined tasks includes delivering the first order to the customer and providing a targeted product offer to the customer, and the targeted product offer is determined using the reason for creating the account.

11. The method of claim 9, wherein:
providing at least one product offer to the customer includes providing at least one targeted product offer that is determined using the at least one lead generated using the customer survey response; and
providing at least one targeted offer to the customer includes:
assessing an interest of the customer toward potential products; and
providing a product offer determined at least in part on the assessed interest.

12. The method of claim 1, wherein providing at least one product offer to the customer includes:
determining at least one product currently used by the customer; and
providing at least one offer for at least one product determined at least in part on the at least one currently-used product.

13. The method of claim 1, wherein performing the number of predetermined tasks includes receiving customer responses to a loyalty survey.

14. A method for retaining a customer, comprising:
receiving a reason for creating an account, wherein the reason is one of a plurality of predetermined reasons;
during a first time period after the account is created, sending a thank you card and an account opening package to the customer using the reason for creating the account;
during a second time period after the first time period, sending a general offer letter with a general product offer to the customer, wherein the general offer is determined using the reason for creating the account;
during a third time period after the second time period, sending a targeted offer letter with a targeted product offer to the customer, wherein the targeted offer is determined using the reason for creating the account.

15. The method of claim 14, wherein the account is a personal account, the method further comprising enrolling the customer in a fraud recovery service during the first time period.

16. The method of claim 15, further comprising:
during a fourth time period after the first time period and before the third time period, receiving a first order from the customer, and receiving customer responses to a lead generation survey;
during a fifth time period after the fourth time period and before the third time period, sending the first order to the customer, and providing a targeted product offer to the customer with the first order, wherein the targeted product offer provided with the first order is determined using the reason for creating the account; and
during a sixth time period after the third time period, receiving customer responses to a loyalty survey.

17. The method of claim 16, wherein:
during the first time period extending from approximately day 3 to approximately day 5 after the account is created, sending the thank you card and the account opening package to the customer, and automatically enrolling the customer in the fraud recovery service;
during the fourth time period extending from approximately day 5 to approximately day 10 after the account is created, receiving the first order from the customer, and receiving customer responses to the lead generation survey;
during the fifth time period extending from approximately day 7 to approximately day 15 after the account is created, sending the first order to the customer, and providing the targeted product offer to the customer with the first order;
during the second time period extending from approximately day 10 to approximately day 14, sending the general offer letter with the general product offer to the customer,
during the third time period extending from approximately day 40 to approximately day 50, sending the targeted offer letter with the targeted product offer to the customer; and
during the seventh time period extending between approximately day 50 to approximately day 70, receiving customer responses to a loyalty survey.

18. The method of claim 14, wherein the account is a business account, the method further comprising:
during a fourth time period after the first time period and before the third time period, receiving a first order from the customer; and
during a fifth time period after the fourth time period and before the third time period, sending the first order to the customer.

19. The method of claim 18, wherein:
during the first time period extending from approximately day 3 to approximately day 5 after the account is created, sending the thank you card and the account opening package to the customer;
during the fourth time period extending from approximately day 5 to approximately day 10 after the account is created, receiving the first order from the customer;
during the fifth time period extending from approximately day 7 to approximately day 15 after the account is created, sending the first order to the customer;
during the second time period extending from approximately day 10 to approximately day 14, sending the general offer letter with the general product offer to the customer, and
during the third time period extending from approximately day 40 to approximately day 50, sending the targeted offer letter with the targeted product offer to the customer.

20. A system comprising:
at least one database containing client records, customer records, account records, and predetermined reason codes for opening an account, wherein each account record includes an account opening date and is associated with a customer record and a selected reason code from the predetermined reason codes, and each customer record is associated with a client record; and
a scheduling module adapted to communicate with the at least one database to retrieve the account opening date, the scheduling module adapted to trigger at least one module to send at least one communication and provide at least one product offer for a selected account record according to a predetermined schedule based on the account opening date,
wherein both the at least one communication and the at least one product offer are based at least in part on the selected reason code for opening the account, and the at least one product offer includes at least one offer for goods, at least one offer for services, or at least one offer for both goods and services.

21. The system of claim 20, wherein:
the at least one communication includes a personalized thank you card for the selected account, and a personalized welcome package based on the reason code associated with the account; and
the scheduling module is adapted to trigger at least one module to send the personalized thank you card according to the predetermined schedule and send the welcome package according to the predetermined schedule.

22. The system of claim 20, wherein the scheduling module is adapted to trigger at least one module to automatically enroll a customer record into a fraud recovery service according to the predetermined schedule.

23. The system of claim 20, wherein:
the at least one product offer includes a targeted product offer based on the selected reason code; and
the scheduling module is adapted to trigger at least one module to provide the targeted product offer with an order for the selected account according to the predetermined schedule.

24. The system of claim 20, wherein:
the at least one product offer includes a non-targeted product offer; and
the scheduling module is adapted to trigger at least one module to provide the non-targeted product offer according to the predetermined schedule.

25. The system of claim 20, wherein:
the at least one database includes a survey result associated with each account;
the at least one product offer includes a targeted product offer based on the selected reason code and the survey result associated with the selected account record; and
the scheduling module is adapted to trigger at least one module to provide the targeted product offer according to the predetermined schedule.

26. The system of claim 20, further comprising:
an order processing module adapted to cooperate with the at least one database and the schedule module to receive order information from the first database for the selected account record, request production of the order and provide order status information to the first database,
wherein the scheduling module is adapted to trigger the order processing module to request production of the order according to a predetermined schedule.

27. The system of claim 20, further comprising a survey module adapted to cooperate with the at least one database and the schedule module to request at least one survey for the selected account according to a predetermined schedule, receive the results of the at least one survey, and transfer the results of the at least one survey to the first database.

28. The system of claim 27, wherein the at least one survey includes a lead generation survey and a loyalty survey.

29. The system of claim 20, further comprising a lead generation module adapted to cooperate with the at least one database and the schedule module to receive at least one lead survey result for the selected account, to receive the reason code associated with the selected account and to generate at least one lead based on the at least one lead survey result for the selected account and the reason code associated with the selected account.

30. The system of claim 20, wherein a client associated with the client records is a financial institution.

31. The system of claim 20, wherein the account record is a personal checking account record.

32. The system of claim 20, wherein the account record is a business checking account record.

33. A system, comprising:
means for receiving a reason for creating an account, wherein the reason code is one of a plurality of predetermined reasons;
means for sending a thank you card during a first time period after the account is created;
means for sending an account opening package to the customer using the reason for creating the account during the first time period;
means for sending a general offer letter with a general product offer to the customer during a second time period after the first time period;
means for determining a targeted product offer using the reason for creating the account; and
means for sending a targeted offer letter with a targeted product offer to the customer during a third time period after the second time period.

34. The system of claim 33, wherein the account is a personal account, the system further comprising means for enrolling the customer in a fraud recovery service during the first time period.

35. The system of claim 34, further comprising:
means for receiving a first order from the customer;
means for receiving customer responses to a lead generation survey;
means for determining a targeted product offer to be provided with the first order using the reason for creating the account;
means for sending the first order to the customer, and a targeted product offer to the customer with the first order; and
means for receiving customer responses to a loyalty survey.

36. The system of claim 33, wherein the account is a business account, the system further comprising:
means for receiving a first order from the customer; and
means for sending the first order to the customer.
